(19) United States
(12) Patent Application Publication
(10) Pub. No.: US 2003/0011750 A1
(43) Pub. Date: Jan. 16, 2003

(54) Display apparatus and method particularly useful in simulators

(75) Inventor: Dekel Tzidon, Had Hasharon (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: ComView Visual Systems Ltd.

(21) Appl. No.: 09/904,589

(22) Filed: Jul. 16, 2001

(51) Int. Cl. G03B 21/26

(52) U.S. Cl. 353/30

(57) ABSTRACT

A method and apparatus for displaying composite images, as viewed from a relatively stationary eye point, including a moving target image of relatively small field-of-view overlaid on a background image of relatively large field-of-view, by generating a background image video stream of image data for the background image; updating the background image video stream at a zero or low data update-rate; generating a target image video stream of image data for the target image; updating the target image video stream at a relatively high data update-rate; combining the background and target image video streams to produce a combined video stream; and feeding the combined video stream to a display system for displaying the composite images. The described preferred embodiment is a simulator, wherein the display system includes a plurality of projectors each projecting a predetermined section of the composite image including the background of the respective section, and the portion of the target in the respective section.

### FIELD AND BACKGROUND OF THE INVENTION

The present invention relates to display apparatus and methods, in which the display includes target images of relatively small surface area (e.g., of a narrow-field of view) superposed on background images of relatively large surface area (e.g., of a wide field of view). The invention is particularly useful in display apparatus and methods for simulators used for training purposes and is therefore described below with respect to such an application, but it will be appreciated that the invention could be used in other applications as well.

The foregoing types of display systems, commonly called area-of-interest display systems, are well known in the prior art, as disclosed for example in U.S. Pat. Nos. 5,326,266, and 5,707,128. Such systems display target images of relatively small surface area (narrow-field of view) superposed on background images of relatively large surface area (wide field of view). When used in simulators, the target images are generally of a higher resolution than the background images, to minimize costs while enabling the trainee to experience, with considerable realism, specific situations to be encountered by the trainee.

Using two projectors, one for the low resolution background image and the other for the high resolution target image, may produce geometrical or color non-uniformities, or seams, between the two images, which would be disturbing to the viewer. Various solutions have been proposed, as described in the above citations, to produce a visually acceptable transition between the two images. For example, the solution proposed in the above-cited U.S. Pat. No. 5,326,266, is to oscillate the target or area-of-interest image with respect to the background image. An edge blending technique is described in the publication P. Lyon, “Edge-Blending Multiple Projection Displays as a Dome Surface to Form Continuous Wide Angle Field of View”, pp 203-207, Proceedings, Nov. 19-21, 1985, 7^{th} Interservice Industry Training Equipment Conference.

A visually acceptable transition could, of course, also be produced by matching the resolutions of the target image and background image, but this would involve either losing the benefits of the high resolution of the target image if its resolution is to be reduced to match that of the background image, or substantially increasing the costs if the resolution of the background image is to be increased to match that of the target image.

### OBJECTS AND BRIEF SUMMARY OF THE INVENTION

An object of the present invention is to provide a display method and apparatus having advantages in the above respects. Another object of the invention is to provide a display method and apparatus particularly useful in simulators.

According to one aspect of the present invention, there is provided a method of displaying composite images, as viewed from a relatively stationary eye point, including a moving target image of relatively small field-of-view overlaid on a background image of relatively large field-of-view, comprising: generating a background image video stream of image data for the background image; generating a target image video stream of image data for the target image; updating the target image video stream at a substantially higher data update-rate than the background image video stream; combining the background and target image video streams to produce a combined video stream; and feeding the combined video stream to a display system for displaying the composite images.

The background image video stream need not be updated at all, and may be separated from a stills picture, for example. Preferably, the data update-rate is 0-1 Hz for the background image video stream and 15-60 Hz for the target image video stream. Such a method enables a substantial reduction in the number of image generators and even the elimination of an image generator for the background image which can be pre-rendered as indicated above.

The foregoing method may be implemented according to a number of embodiments, such as wherein: a plurality of background image video streams are sequentially inputted, each representing a section of the composite image displayed; a plurality of target image video streams are inputted, each representing a different target of the composite image displayed; one target image video stream is inputted having a plurality of different targets of the composite image; or a plurality of target image video streams are inputted each including a plurality of different targets of the composite image.

According to another aspect of the present invention, there is provided apparatus for displaying composite images as viewed from a relatively stationary eye point, including moving target images of relatively small field-of-view overlaid on background images of relatively large field-of-view, comprising: a background image generator for generating a video stream of background image data; a target image generator for generating a video stream of target image data; a data controller for updating the video stream of target image data at a substantially higher data update-rate than the video stream of background image data; a visual controller for combining the updated video streams of target image data and background image data; and a display system for receiving the combined updated video streams of target image data and background image data, and for displaying the composite images therefrom. The background image generator may be in a separate unit or included in the usual controller.

According to a preferred embodiment described below, the display system includes a plurality of projectors each projecting a predetermined section of the composite image; the background image generator generates a background video stream which includes background image data for a section of the composite image and location data identifying the respective section in the composite image; and the target image generator generates a target video stream which includes target image data and location data identifying the location of the target image data in the composite image.

According to further features in the latter preferred embodiment, the visual controller includes a frame buffer for each of the projectors, and each frame buffer is updated with its respective background image data at the zero or low data update-rate, and with its respective target image data at the relatively high data update-rate.

According to a still further aspect of the present invention, there is provided simulator apparatus for displaying composite images, as viewed from a relatively stationary eye point, including moving target images of relatively small field-of-view overlaid on background images of relatively large field-of-view, comprising: a plurality of projectors each projecting a predetermined section of the composite image; a background image generator for generating a video stream of background image data for each section of the composite image, and location data for identifying the respective section in the composite image; a target image generator for generating a target image video stream including target image data and location data identifying the location of the target image data in the composite image; a data controller for updating the image generator of target image data at a substantially higher data update-rate than the image generator of background image data; and a visual controller for combining the updated video streams of target image data and background image data, and for sequentially feeding same to the plurality of projectors of the display system.

It is to be noted that since the observer eye point is stationary, the changes that occur in the background image data, such as those due to changes in time, will occur very slowly with only a small change in each step. Thus, when the display system includes an array of projectors according to the preferred embodiment described below, the updating of each segment at a time may be effected substantially unnoticeably.

As will be described more particularly below, such apparatus and method avoid the transition problem between a high resolution target image and a low resolution background image heretofore involved in the prior art, since it enables both the target image and the background image to be of the same resolution, without lowering the resolution of the target image or inordinately increasing the costs for increasing the resolution of the background image. These advantages are particularly important in simulators as they enable simulators of relatively high resolution to be constructed at relatively low cost.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a flow chart illustrating a simplified method of displaying composite images in accordance with the present invention;

FIG. 2 is a flow chart illustrating a method of displaying composite images when using a plurality of projectors in a modular arrangement for projecting a plurality of sections of an overall composite image;

FIG. 3 is a block diagram illustrating one form or apparatus constructed in accordance with the invention to operate according to the flow chart of FIG. 2; and

FIG. 4 is a block diagram more particularly illustrating the operation of the background and target image generators in a projector system according to FIG. 3 but showing only two of the projectors for purposes of simplifying the description.

### DESCRIPTION OF PREFERRED EMBODIMENTS

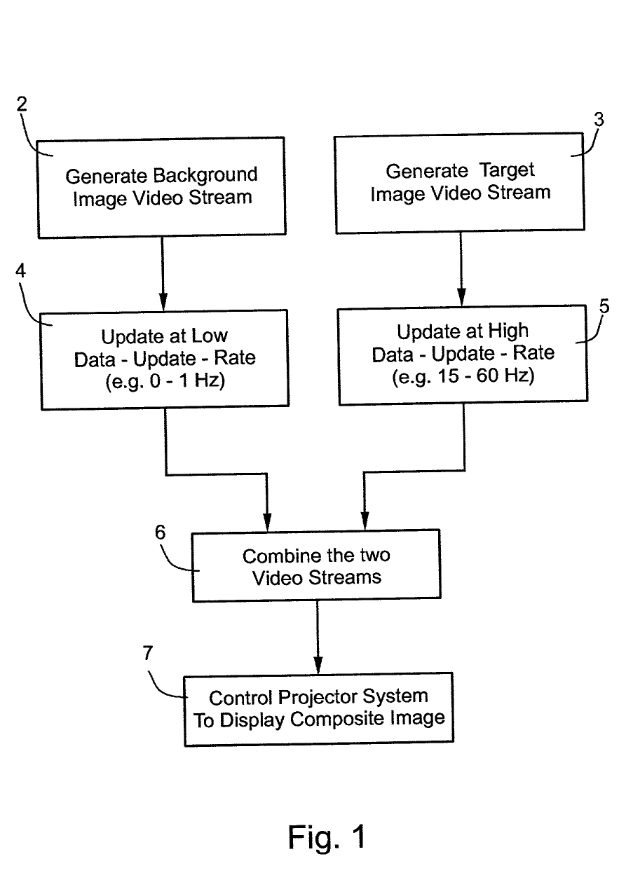

FIG. 1 is a simplified flow chart illustrating a method of displaying composite images in accordance with the present invention. The composite images displayed are those as viewed from a relatively stationary eye point, so as to include a moving target image of relatively small field-of-view overlaid on a background image of relatively large field-of-view. For example, in an air controller system, the moving target images would be aircraft, and the background image would be the environment (e.g., terrain, cloud formation, etc.) in which the aircraft travels. In a land vehicle control system (e.g., trucks, buses, etc.), the target images would be the land vehicles, and the background image would be the terrain, roads, intersections, etc. over which the vehicles travel.

In a simulator system used for training purposes, the target image data and background image data would be stored and retrieved to simulate particular events.

As shown in FIG. 1, the novel method involves generating a background image video stream of image data for the background image (block 2), and also generating a target image video stream of image data for the target image (block 3). The background image video stream is updated at a “0” or low data update-rate, e.g., 0-1 Hz (block 4); whereas the target image video stream is updated at a high data update-rate, e.g., 15-60 Hz (block 5). The two video streams are combined (block 6) and fed to a projector system for displaying the composite image (block 7).

Although only one target is involved in the flow chart of FIG. 1, it will be appreciated that there could be a plurality of targets each having a target image video stream, or a part of a target image video stream updated at the high data update-rate.

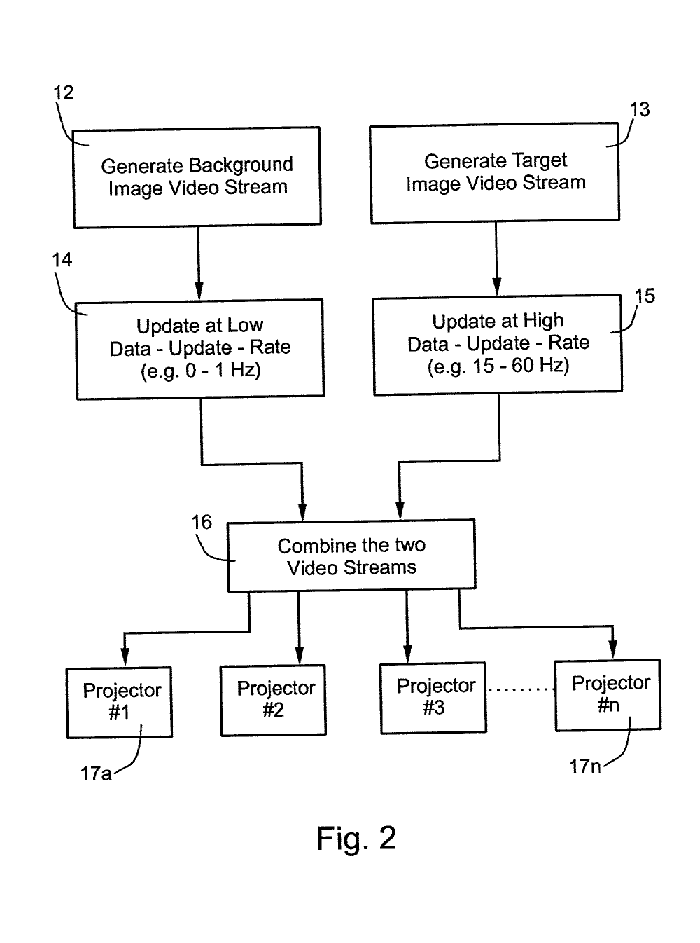

As indicated above, the flow chart FIG. 1 is a simplified illustration of a method of displaying composite images in accordance with the present invention. A more preferred system is illustrated in the flow chart of FIG. 2, involving a plurality of projectors each projecting a predetermined section of a large composite image.

Thus, as shown in FIG. 2, the generated background image video stream includes image data for the respective background section, plus the location of the respective background section in the large composite image (block 12); and similarly the generated target image video stream includes image data for the respective target, and also location data defining the location of the target in one or more of the sections of the large composite image (block 13). As in the system illustrated in FIG. 1, the background image video stream is updated at a “0” or low data-update-rate, e.g., 0-1 Hz (block 14); and the target image video stream is updated at a high data update-rate, e.g., 15-60 Hz (block 15). Both video streams are combined (block 16), e.g., in a visual controller as will be described more particularly below, which controller sequentially controls the plurality of projectors, shown at 17a—17n in FIG. 2, so that each projector projects its respective section of the large composite image including the respective background image, and the respective portion of the target image, if any, in the respective section.

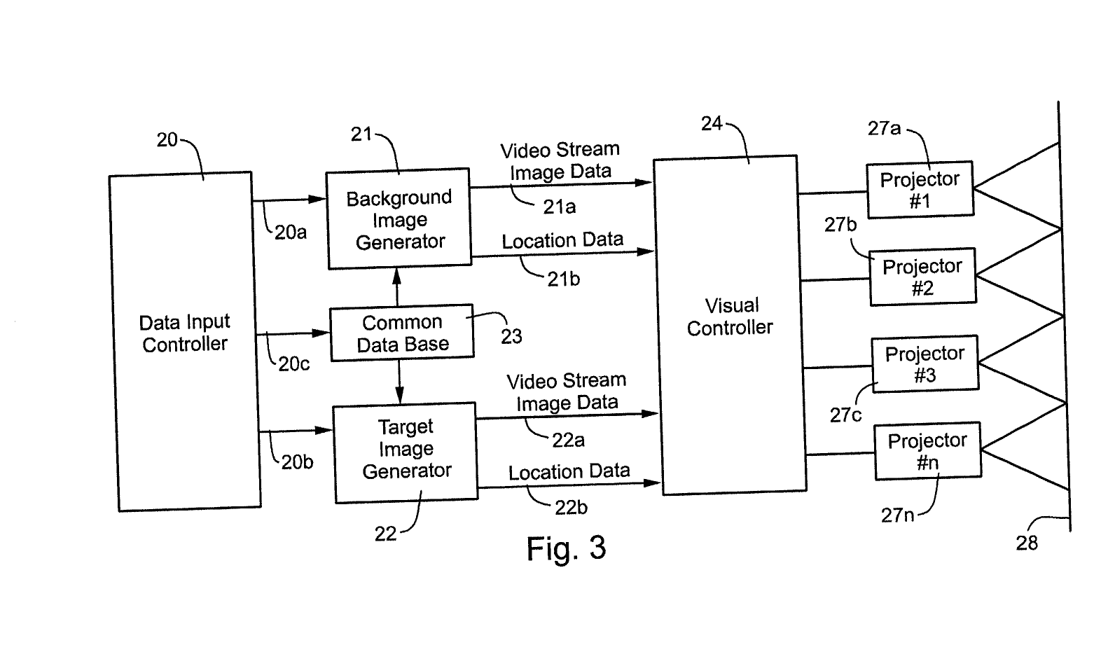

A multi-projector system as illustrated by the flow chart of FIG. 2 is more particularly illustrated in the block diagram of FIG. 3. Such a system includes a data input controller 20 which controls a background image generator 21 and a target image generator 22.

Preferably, a separate database 23 is provided, also controlled by controller 20, which database contains the data to be utilized by the background image generator 21 and the target image generator 22. Database 23 may include, for example, terrain data, layout maps, etc., to be used in displaying the composite images including the background and the moving target or targets. The data input controller 20 controls the operation of the two image generators 21, 22, and the database 23, by command lines schematically shown at 20a, 20b and 20c, respectively.

The video streams produced by the background image generator 21 and the target image generator 22 are combined in a visual controller 24, which controls the operation of the plurality of projectors 27a—27n. Thus, the output of the background image generator 21 includes an output line 21a feeding the video stream of background image data to the visual controller for each of the sections of the large composite image to be displayed by the plurality of projectors 27a—27n, and an output line 21b for feeding the location of the respective background sections, i.e., the respective projector 27a—27n. Similarly, the target image generator 22 includes an output line 22a to the visual controller 24 for feeding thereto the video stream of target image data for each of the sections of the large composite image, and an output line 22b identifying the location of the target image data, in any, in the respective section of the large composite image to be displayed.

It will thus be seen that the visual controller 24 receives from the background image generator 21 the background image video stream for each section of the large composite image to be projected updated at a data update-rate of, e.g., 0-1 Hz. Controller 24 also receives the target image video stream for each section of the large composite image to be projected but updated at a high data-update-rate, e.g., 15-60 Hz. The visual controller 24 in turn sequentially controls the plurality of projectors 27a—27n, so that each projector projects on a common screen, shown at 28, the respective section of the background image, as well as the respective target image, if any, included in the respective section of the background image.

As indicated earlier, the background image involves changes that occur very slowly, if at all, such as changes due to the time of day, and therefore each section of the overall composite image may be updated with respect to the background image data at the “0” or very low update-rate (0-1 Hz) in a manner which will be substantially unnoticeable to the viewer. On the other hand, the moving target image data changes very rapidly, and therefore is updated at the high update-rate (e.g., 15-60 Hz) in order to display in a relatively high-resolution manner the fast-changing target image.

While each image generator 21, 22, illustrates two output lines (21a, 21b and 22a, 22b, respectively), it will be appreciated that this is shown merely for convenience, and that both types of data (image and location) could be outputted from the respective generator 21, 22, via the same output line.

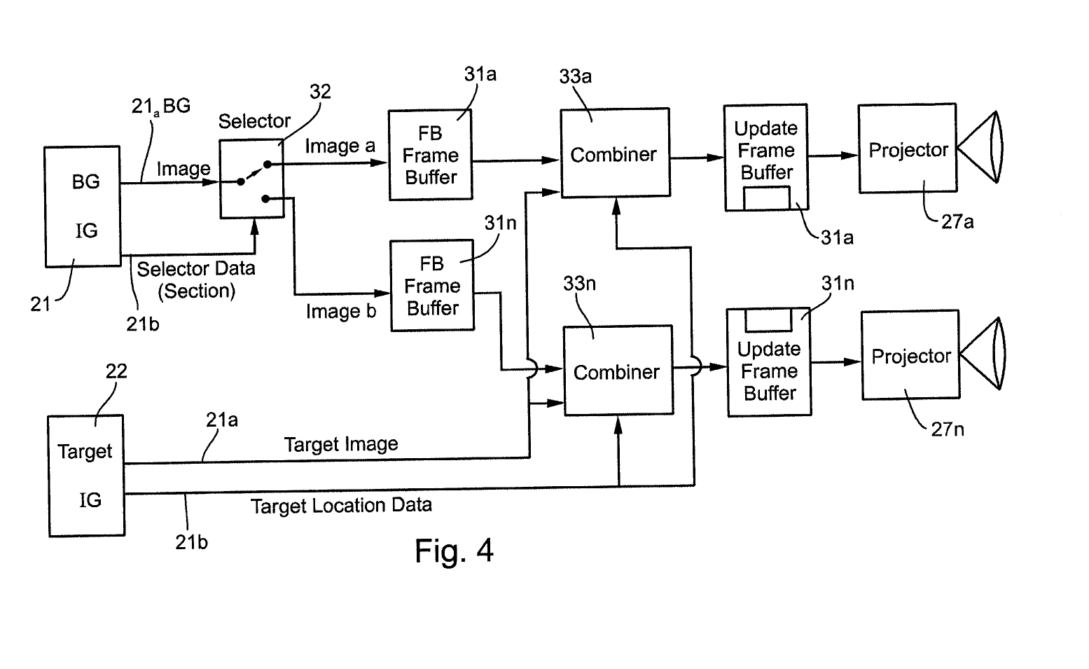

The visual controller 24 is more particularly illustrated in the block diagram of FIG. 4. For simplification purposes, it is therein illustrated as controlling but two projectors, namely projector 27a and 27n. Thus, it includes a frame buffer 31a—31n, one for each of the projectors 27a—27n to contain the data from the background image generator 21 and target image generator 22 to be projected by the respective projector. Visual controller 24 further includes circuitry which acts as a selector, shown at 32, for steering the background image data from the background image generator 21 to the respective frame buffer 31a-31n. Visual controller 24 includes further circuitry, schematically shown at 33a, 33n, for combining the target image data from the target image generator 22 with the background image for the respective section, as received from the background image generator 21, to update the frame buffers 31a—31n at their respective update-rates as described above, before the data of each frame buffer is projected by its respective projector 27a—27n.

The visual controller 24 is preferably of the type described in U.S. Pat. No. 6,219,011, the disclosure which is incorporated herein by reference. Such a visual controller not only controls the plurality of projectors to produce a large, combined display, but also enables distortions in the individual projectors to be corrected, such that the large combined display is relatively distortion-free with respect to geometry, color and light intensity of the images produced by each projector.

While FIGS. 3 and 4 illustrate, respectively, only four projectors and two projectors, it will be appreciated that the described system is a modular system which can accommodate any desired number of projectors according to the desired size of the display or desired field of view. As indicated earlier, the described system is particularly useful in training simulators to provide the combined advantages of high overall resolution (both of the background and target), as well as seamless, and distortion-free transitions between the different images.

It will also be appreciated that, particularly when used in simulators, the apparatus can accommodate not only a plurality of target images, but also target images of different types, e.g., slow-moving and fast-moving, different sizes of FOVs, and also different types of background images, e.g., relatively static background images, such as terrain, and dynamic slow-moving images, such as cloud formations. Thus, by tailoring the data-update-rate according to the rate of change of the respective image, the system can achieve relatively high overall resolution and relatively seamless and distortion-free transitions at a relatively low cost.

For example, a plurality of background image video streams could be sequentially inputted, each representing a section of the composite image displayed. In addition, a plurality of target image video streams could be inputted, each representing a different target of the composite image displayed. Another option would be to input one target image video stream having a plurality of different targets of the composite image; and a still further option would be to input a plurality of target image video stream each having a plurality of different targets of the composite image.

While the invention has been described with respect to several preferred embodiments, it will be appreciated that these are set forth merely for purposes of example, and that many other variations, modifications and applications of the invention may be made.

What is claimed is:

1. A method of displaying composite images, as viewed from a relatively stationary eye point, including a moving target image of relatively small field-of-view overlaid on a background image of relatively large field-of-view, comprising:
inputting a background image video stream of image data for said background image;
inputting a target image video stream of image data for said target image;
updating said target image video stream at a substantially higher data update-rate than said background image video stream;
combining said background and target image video streams to produce a combined video stream;
and feeding said combined video stream to a display system for displaying said composite images.

2. The method according to claim 1, wherein:
said display system includes a plurality of projectors each projecting a predetermined section of the composite image;
said background image video stream includes background image data for a section of the composite image and location data identifying the respective section in the composite image;
said target image video stream includes target image data and location data identifying the location of the target image data in the composite image.

3. The method according to claim 2, wherein there is a frame buffer for each of said projectors, and each frame buffer is updated with its respective background image data at said zero or low data update-rate, and with its respective target image data at said relatively high data update-rate.

4. The method according to claim 1, wherein said background image video stream represents a non-changing background and is not updated during the updating of said target image video stream.

5. The method according to claim 1, wherein said background image video stream is generated from a still picture.

6. The method according to claim 1, wherein said background image video stream is updated at a data update-rate of 0-1 Hz, and said target video image stream is updated at a data update-rate of 15-60 Hz.

7. The method according to claim 1, wherein a plurality of background image video streams are sequentially inputted, each representing a section of the composite image displayed.

8. The method according to claim 1, wherein a plurality of target image video streams are inputted, each representing a different target of the composite image displayed.

9. The method according to claim 1, wherein one target image video stream is inputted having a plurality of different targets of the composite image.

10. The method according to claim 1, wherein a plurality of target video image streams are inputted each including a plurality of different targets of the composite image.

11. The method according to claim 1, wherein the display of said background image video stream and said target image video stream is controlled by a simulator.

12. Apparatus for displaying composite images, as viewed from a relatively stationary eye point, including moving target images of relatively small field-of-view overlaid on background images of relatively large field-of-view, comprising:
a background image generator for generating a video stream of background image data;
a target image generator for generating a video stream of target image data;
a data controller for updating said video stream of target image data at a substantially higher data update-rate than said video stream of background image data;
a visual controller for combining said updated video streams of target image data and background image data;
and a display system for receiving said combined updated video streams of target image data and background image data, and for displaying said composite images therefrom.

13. The apparatus according to claim 12, wherein said visual controller includes a frame buffer which is updated with the background image data at a zero or low data-update-rate, and with said target image data at said substantially higher data-update-rate.

14. The apparatus according to claim 13, wherein said frame buffer is updated with the background image data at a data update-rate of 0-1 Hz, and the target image data at a data update-rate of 15-60 Hz.

15. The apparatus according to claim 12, wherein said background image generator is within said visual controller.

16. The apparatus according to claim 12, wherein said background image generator generates said video stream of background image data from a stills picture.

17. The apparatus according to claim 12, wherein:
said display system includes a plurality of projectors each projecting a predetermined section of the composite image;
said background image generator generates a background video stream which includes background image data for a section of the composite image and location data identifying the respective section in the composite image;
and said target image generator generates a target video stream which includes target image data and location data identifying the location of the target image data in the composite image.

18. The apparatus according to claim 17, wherein said visual controller includes a frame buffer for each of said projectors, and each frame buffer is updated with its respective background image data at said zero or low data update-rate, and with its respective target image data at said relatively high data update-rate.

19. The apparatus according to claim 18, wherein said low data update-rate is 0-1 Hz, and said high data update-rate is 15-60 Hz.

20. The apparatus according to claim 12, wherein said data controller is a simulator.

21. A simulator for displaying composite images, as viewed from a relatively stationary eye point, including moving target images of relatively small field-of-view overlaid on background images of relatively large field-of-view, comprising:
a plurality of projectors each projecting a predetermined section of the composite image;
a background image generator for generating a video stream of background image data for each section of the composite image, and location data for identifying the respective section in the composite image;
a target image generator for generating a target image video stream including target image data and location data identifying the location of the target image data in the composite image;
a data controller for updating said image generator of target image data at a substantially higher data update-rate than said image generator of background image data;
and a visual controller for combining said updated video streams of target image data and background image data and for sequentially feeding same to the plurality of projectors of the display system.

22. The apparatus according to claim21, wherein said visual controller includes a frame buffer for each of said projectors, and each frame buffer is updated with its respective background image data at a zero or low data update-rate, and with its respective target image data at said substantially higher data update-rate.

23. The apparatus according to claim 21, wherein said background image generator is within said visual controller.

24. The apparatus according to claim 21, wherein said background image generator generates said video stream of background image data from a stills picture.
